(19) United States
(12) Patent Application Publication
(10) Pub. No.: US 2017/0177701 A1
(43) Pub. Date: Jun. 22, 2017

(54) SYSTEMS AND METHODS FOR SMART ANALYTICS INTERFACE

(71) Applicant: SAP SE, Walldorf (DE)

(72) Inventors: Virat Tiwari, Walldorf (DE); San Tran, Hockenheim (DE)

(21) Appl. No.: 14/976,638

(22) Filed: Dec. 21, 2015

(51) Int. Cl. G06F 17/30

(52) U.S. Cl. CPC G06F 17/30592

(57) ABSTRACT

According to some embodiments, a communication port may receive electronic messages containing business intelligence elements, key figures, and a stream of big data. A smart analytics platform may automatically execute a context determination tool, an expert knowledge tool, and a data interpretation tool using the business intelligence elements, key figures, and stream of big data. The smart analytics platform may then render a smart analytics interface display on a remote user device via a distributed communication network. The smart analytics interface display may, for example, include outputs of the context determination tool, expert knowledge tool, and data interpretation tool.

### BACKGROUND

Enterprise software systems may receive, generate and store data related to many aspects of a business. These systems may provide reporting, planning, and/or analysis of the data based on logical entities such as business intelligence elements, dimensions, measures, key figures, and/or a stream of big data. Typical analytics and business intelligence applications let users create reports to display key figures and data on a table control, which can be optionally visualized on an appropriate graphical chart. However in the current context of “big data” this classic reporting style may not be sufficient. For example, such reports may not explain the business meaning of a specific key figure (e.g., what is the likely effect of a 15% volume decrease effect on margin?) or whether a certain key figure will have a positive or negative effect on a business. Similarly, typical interfaces do not inform a user about the next logical analysis steps that might be appropriate or which other related reports and/or key figures can be additionally investigated.

Thus, approaches to provide improved business information report analytics in a fast, simple, and accurate manner may be desired.

### BRIEF DESCRIPTION OF THE DRAWINGS

FIG. 1 is a block diagram of a system according to some embodiments.

FIG. 2 is a flow diagram of a process according to some embodiments.

FIG. 3 illustrates context awareness design principles according to some embodiments.

FIG. 4 is an example of an interpretation mechanism according to some embodiments.

FIG. 5 illustrates a visually focused display in accordance with some embodiments.

FIG. 6 is an example story telling approach according to some embodiments.

FIG. 7 is an example a textual interface display according to some embodiments.

FIG. 8 illustrates some aspects of an interpretation mechanism in accordance with some embodiments.

FIG. 9 is a block diagram of a smart analytics platform according to some embodiments.

FIG. 10 is a portion of a tabular representation of a business information database in accordance with some embodiments.

FIG. 11 illustrates a handheld tablet computer that may be associated with any of the embodiments described herein.

FIG. 12 is a block diagram of a system according to some embodiments.

### DETAILED DESCRIPTION

Enterprise software systems may receive, generate and store data related to many aspects of a business. These systems may provide reporting, planning, and/or analysis of the data based on logical entities such as business intelligence elements, key figures, and/or a stream of big data. As used herein, the phrase “business intelligence” may refer to elements associated with a transformation of raw data into meaningful and useful information for business analysis purposes. Business intelligence technologies are capable of handling large amounts of unstructured data to help identify, develop and otherwise create new strategic business opportunities.

Typical analytics and business intelligence applications let users create reports to display key figures and data on a table control, which can be optionally visualized on an appropriate graphical chart. However in the current context of “big data” this classic reporting style may not be sufficient. As used herein, the phrase “big data” may refer to, for example, data sets so large or complex that traditional data processing applications may be inadequate. Challenges associated with big data include analysis, capture, data curation, search, sharing, storage, transfer, and visualization. Note that traditional business reports may not explain the business meaning of a specific key figure (e.g., what is the likely effect of a 15% volume decrease effect on margin?) or whether a certain key figure will have a positive or negative effect on a business. Similarly, typical interfaces do not inform a user about the next logical analysis steps that might be appropriate or which other related reports and/or key figures can be additionally investigated.

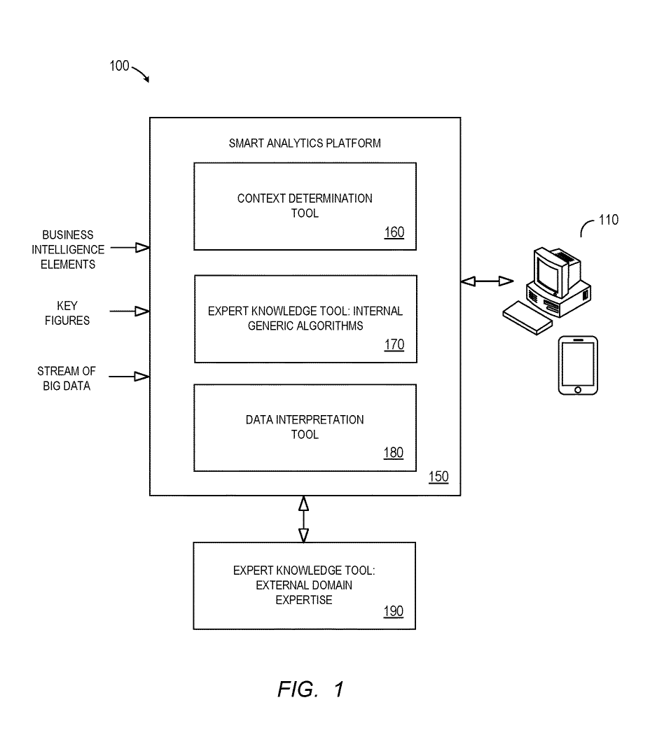

Thus, approaches to provide improved business information report analytics in a fast, simple, and accurate manner may be desired. In particular, FIG. 1 is a block diagram of a system 100 according to some embodiments. FIG. 1 represents a logical architecture for describing processes according to some embodiments, and actual implementations may include more or different components arranged in other manners. The system 100 includes user devices 110, such as Personal Computers (“PCs”), smartphones, etc. that may access a smart analytics platform 150.

The smart analytics platform 150 may receive business intelligence elements, key figures, one or more streams of big data, etc. The smart analytics platform 150 may analyze and/or interpret this data before using the information to render a display via the remote user device 110. In particular, a context determination tool 160, an expert knowledge tool associated with internal generic algorithms 170, and a data interpretation tool 180 within the smart analytics platform 150 may be utilized. According to some embodiments, an expert knowledge tool associated with external domain expertise 190 may also be utilized.

Any of the information received by the smart analytics platform 150 might be associated with a multi-dimensional database, an eXtendable Markup Language (“XML”) document, and/or any other structured data storage system. The physical tables of the system 100 may be distributed among several relational databases, multi-dimensional databases, and/or other data sources. For example, data sources may comprise one or more OnLine Analytical Processing (“OLAP”) databases (i.e., cubes). To provide economies of scale, a data source may include data of more than one customer. In this scenario, the system 100 may include mechanisms to ensure that a client accesses only the data that the client is authorized to access. Moreover, the data of a data source may be indexed and/or selectively replicated in an index.

One or more data sources may implement an “in-memory” database, in which volatile (e.g., non-disk-based) storage (e.g., Random Access Memory (“RAM”)) is used both for cache memory and for storing data during operation, and persistent storage (e.g., one or more fixed disks) is used for offline persistency of data and for maintenance of database snapshots. Alternatively, volatile storage may be used as cache memory for storing recently-used database data, while persistent storage stores data. In some embodiments, the data comprises one or more of conventional tabular data, row-based data stored in row format, column-based data stored in columnar format, and object-based data.

The information from the data sources might be associated with an OLAP cube according to some embodiments. As described above, embodiments are not limited to OLAP technology or to three-dimensional datasets. The OLAP cube might store measure values corresponding to combinations of orthogonal dimension values. Specifically, for each combination of dimension values (e.g., Q1, Asia, Camera), the cube might store a value of the measure Sales and a value of the measure Profit. In other words, each measure value stored in the cube might be associated with a set of dimension values.

According to some embodiments, an “automated” system 100 may facilitate the provision of information to clients. As used herein, the term “automated” may refer to, for example, actions that can be performed with little (or no) intervention by a human.

As used herein, devices, including those associated with the system 100 and any other device described herein may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks. Although the system 100 has been described as a distributed system, note that the system 100 may be implemented in some embodiments by a single computing device. Although a smart analytics platform 150 is shown in FIG. 1, any number of such devices may be included. Moreover, various devices described herein might be combined according to embodiments of the present invention.

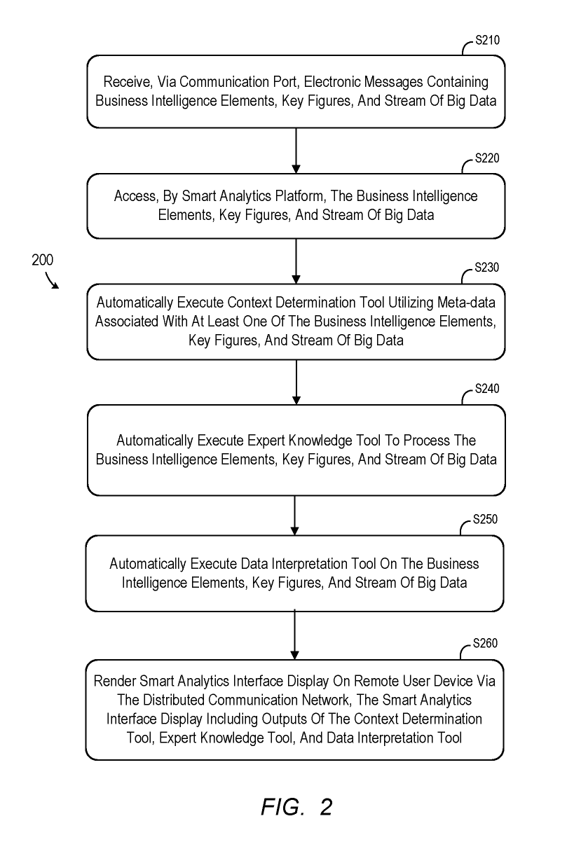

Note that the system 100 of FIG. 1 is provided only as an example, and embodiments may be associated with additional elements or components. According to some embodiments, the elements of the system 100 facilitate an exchange of information to and from a user. FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, a communication port receives electronic messages containing business intelligence elements, key figures, and a stream of big data. At S220, a smart analytics platform, coupled to the communication port and a user interface, may access the business intelligence elements, key figures, and stream of big data.

At S230, the smart analytics platform may automatically execute a context determination tool utilizing meta-data associated with at least one of the business intelligence elements, key figures, and stream of big data. The context determination tool may, for example, leverage received information by adding additional facts or values, reduce information noise, and/or suggest related elements based on available contextual information.

At S240, the smart analytics platform may automatically execute an expert knowledge tool to process the business intelligence elements, key figures, and stream of big data. According to some embodiments, the expert knowledge tool is associated with internal, generic best-practices algorithms (e.g., outlier analysis, trend identification, a plan versus actual comparison, etc.). According to some embodiments, the expert knowledge tool comprises external domain expertise to model domain specific rules.

At S250, the smart analytics platform may automatically execute a data interpretation tool on the business intelligence elements, key figures, and stream of big data. The data interpretation tool may, for example, determine hidden correlations, patterns, and/or drivers associated with an enterprise. According to some embodiments, the data interpretation tool operates based at least in part on an enterprise role associated with the user (e.g., more experienced or technical people may need different levels of information as compared to a newly hired manager).

By way of examples, the data interpretation tool might be configured to perform one or more of the following tasks: explain a business meaning of a specific key figure, explain an impact a specific key figure has on an enterprise, explain the consequences of a specific key figure, explain at least one decision that needs to be made along with a set of options associated with that decision, explain at least one next logical analysis step, suggest related reports or key figures, and/or propose other business aspects that may be associated with a specific key figure. According to some embodiments, the data interpretation tool is configured to receive from the user a request for increased data interpretation and, responsive to the received request, provide additional support information.

According to some embodiments, the data interpretation tool includes a visual focus component, a comprehension component, and a textual conclusion component. The visual focus component may be, for example, associated with a heat map. The comprehension component may, for example, bring multiple perspectives of analysis by providing an overview to explain a specific key figure, suggesting dimensions via a relationship analyzer, accessing pre-determined dimensions and key figures, and/or summarizing findings (e.g., to be provided to the user in human readable language).

At S260, a smart analytics interface display may be rendered on a remote user device via a distributed communication network, the smart analytics interface display including outputs of the context determination tool, expert knowledge tool, and data interpretation tool.

In this way, the smart analytics platform may provide means to understand and interpret business results. It may unveil hidden correlations, facts, patterns, and/or different drivers that affect the business. Eventually, such an approach may help an end user digest big data and take more precise, informed decisions. Furthermore, embodiments may utilize fundamental design principles that form core pillars of an application development.

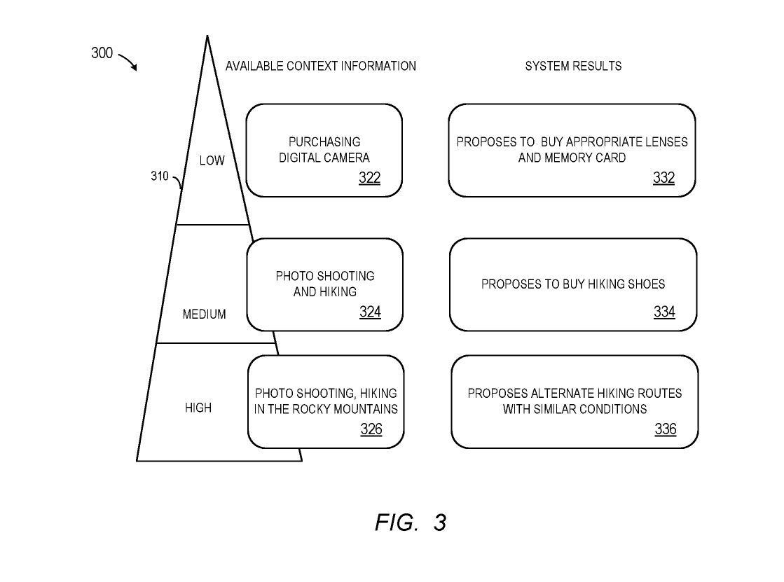

FIG. 3 illustrates context awareness design principles 300 according to some embodiments. Context environments 310 may range from a “low” amount of context information to “high” amount of context information. For example, when the available context information indicates a user is purchasing a digital camera 322, the system may respond with a result that suggests he or she also purchase appropriate camera lenses and/or memory cards 332. Similarly, when the available context information indicates a user is going photo shooting and hiking 324, the system may respond with a result that suggests he or she also purchase hiking shoes 334. Still further, when the available context information indicates a user is going photo shooting and hiking in the Rocky Mountains 326, the system may respond with a result that suggests alternate hiking routes with similar conditions 336 (e.g., perhaps based on local weather information). By taking the context into account, the system may provide means to leverage given information in the current analysis and enrich it with additional facts and values. Moreover, being context aware may help to minimize information noise and direct focus to the most relevant elements. In general, the more context information is available, the more precise guidance can be provided.

According to some embodiments, expertise may provide a better interpretation of a report. The expertise can be provided either internally or externally to system. In the case of internal expertise, the system may use generic best-practices algorithms such as outlier, trend, plan/actual, etc. in order to process specific analysis. In the case of external expertise, the system may import external domain expertise. This may help the system model domain specific rules, which can difficult to identify in a generic way.

Note that a system may support data interpretation such that it is performed only when requested (e.g., on a user's demand). In general, the more domain expertise an end user has, the less system support on interpretation he or she will desire. This passive/defensive approach may help avoid flooding the end user with too much information on the screen by default (which might be overwhelming and distract the end user from the original analysis).

According to some embodiments, the system may provide a consistent unified user experience by performing analysis based at least in part on information about a user group (business user/key user, senior manager/analyst, expertise level, etc.). As a result, the system may cater to the analytical requirements of each user type.

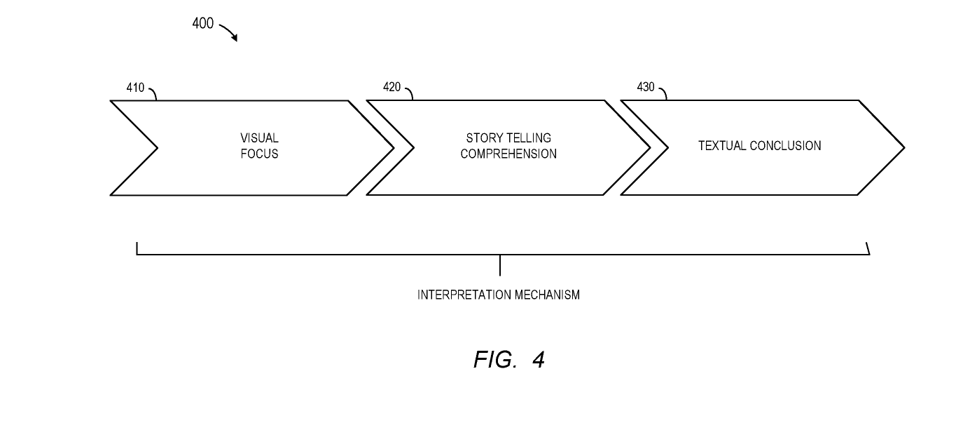

FIG. 4 is an example 400 of an interpretation mechanism 400 according to some embodiments. The system interpretation may be implemented in a way that helps the end user identify the focus area of analysis, guides him or her through subsequent steps, and helps him or her reach conclusions. The interpretation mechanism 400 is divided into the following categories, each with different challenges: visual focus 410, story telling comprehension 420, and textual conclusion 430.

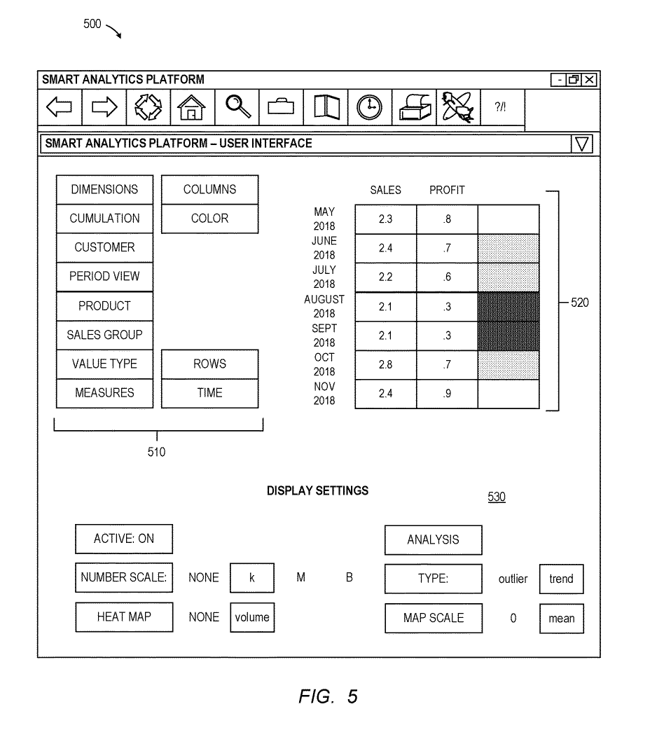

FIG. 5 illustrates a visually focused display 500 in accordance with some embodiments. The display 500 includes a user customization area 510, a heat map 520, and display setting 530. Note that graphical indications such as color can convey information better than numbers, and with that philosophy the system may present the data in way that lets the end user quickly identify the focus area of analysis within the current context of the report. For example, by applying the heat map 520 on a table control (e.g., using greyscale in the example of FIG. 5), it is possible to indicate a problematic key figure without knowing the absolute values. Eventually, this visual element enriches the analysis with additional information in a subtle way.

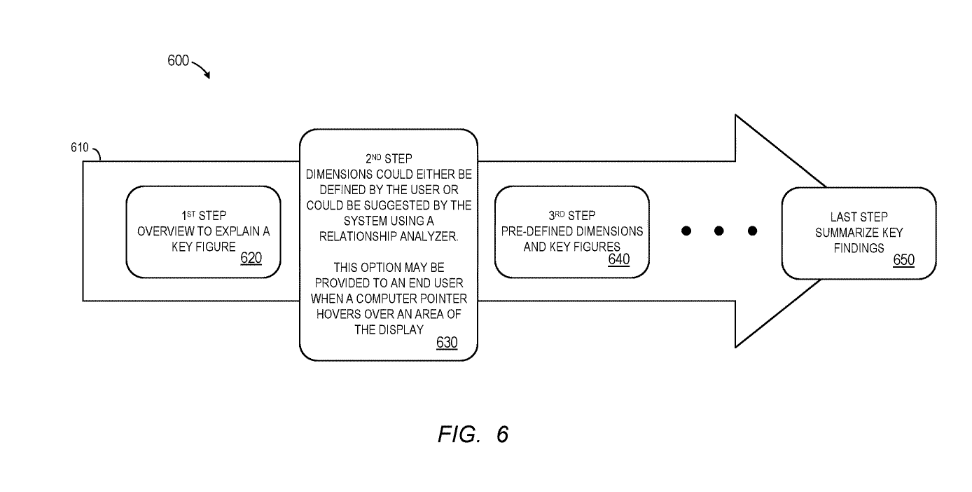

FIG. 6 is an example story telling approach 600 according to some embodiments. To get a full understanding of the business, another mechanism that may be used is story telling. The story telling lets a user comprehend a certain business scenario by bringing in multiple perspectives of analysis those are stitched together to a get a conclusive picture. The stitched perspective explains the analysis in a well-directed 610 order and flow. For example, a first step 620 may be to provide an overview to explain a key figure. A second step 630 may be to determine dimensions that could either be defined by the user or suggested by the system using a relationship analyzer. A third step 640 may be to provide pre-defined dimensions and key figures to the user. Finally, a last step 650 may be to summarize key findings for the user.

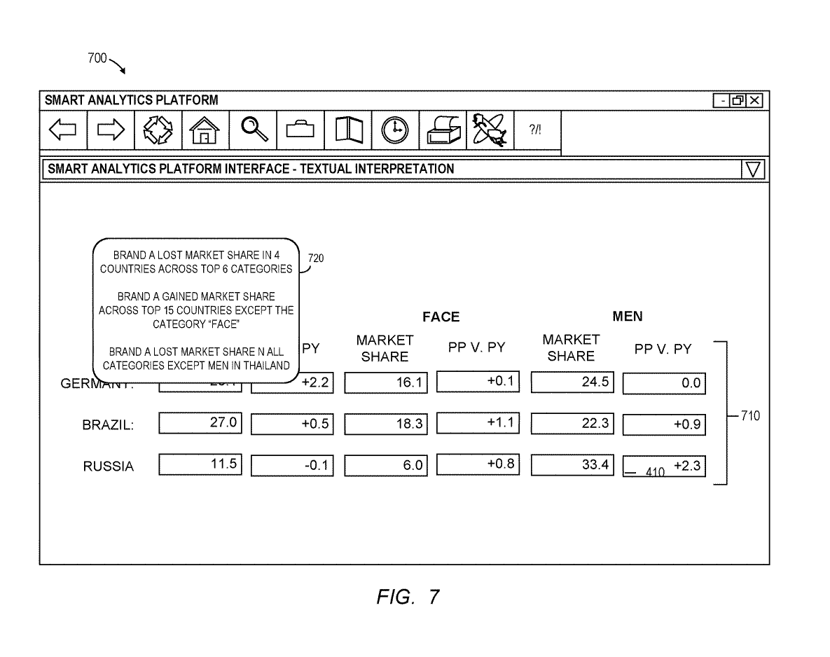

FIG. 7 is an example a textual interface display 700 according to some embodiments. The display 700 include market share information 710 associated with a product being sold in a number of different countries. The display 700 further includes a textual summary of key findings for the user 720. Interpreting and translating the analysis results and data into an appropriate human readable language may help the user make appropriate conclusions. For example, instead of showing a measure only and leaving the interpretation to the user, the system could automatically provide the user with a summary of the analysis and associated facts.

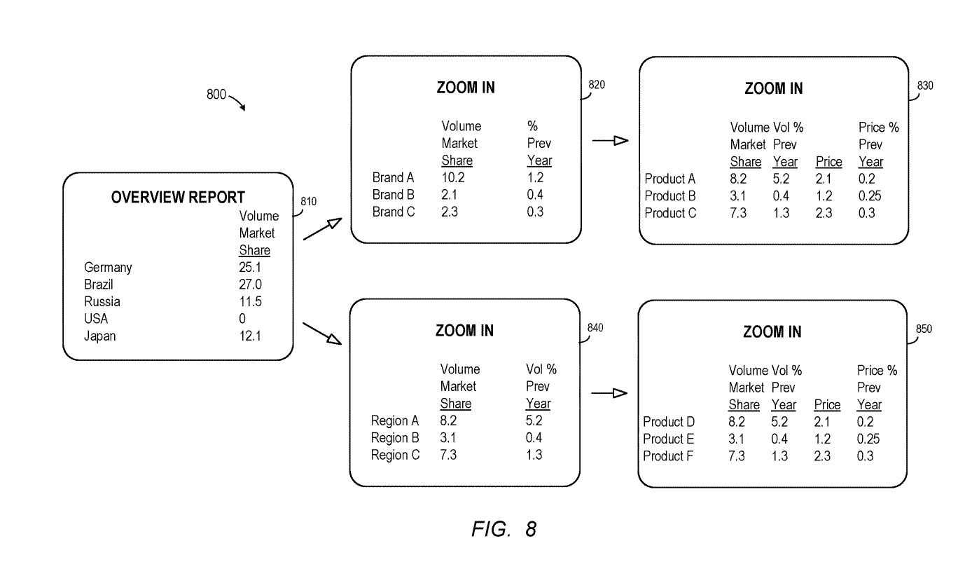

FIG. 8 illustrates some aspects of an interpretation mechanism 800 in accordance with some embodiments. In particular, an overview report 810 may display volume market share for a number of different countries (e.g., Germany, Brazil, Russia, etc.). The report 810 might, for example, give a user different perspectives to let him or her identify points of focus that may be interest (e.g., by slicing and dicing the data to identify problem areas for further analysis). According to some embodiments, the system may automatically supplement the report 810 (e.g., with a number of new products launched, price changes, distribution details, and/or conclusions that might be drawn in view of the data to help the user make decisions). The user might also follow connected paths to help explain the root cause behind or more aspects of the overview report 810. For example, the user might view a market volume comparison to a previous year on a brand-by-brand basis 820 and/or price information based on various products 830. As another example, the user might view a market volume comparison to a previous year on a region-by-region basis 840 and/or price information based on various products 850. Note that the system may again automatically supplement information provided on these “zoom in” displays (e.g., with an explanation of market share changes and/or an indication of which region gained the most market share). According to some embodiments, the system may collect important facts and details about a current report and help a user comprehend various pieces of different aspects of the data.

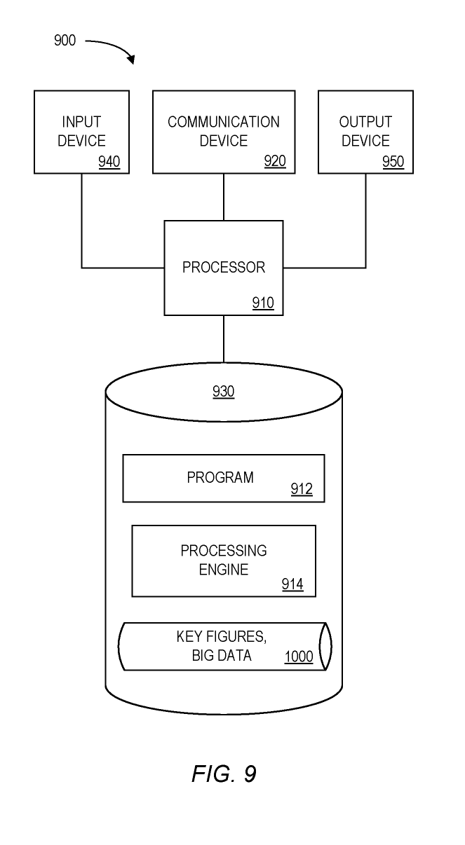

The embodiments described herein may be implemented using any number of different hardware configurations. For example, FIG. 9 illustrates a smart analytics platform 900 that may be, for example, associated with the system 100 of FIG. 1. The smart analytics platform 900 comprises a processor 910, such as one or more commercially available Central Processing Units (CPUs) in the form of one-chip microprocessors, coupled to a communication device 920 configured to communicate via a communication network (not shown in FIG. 9). The communication device 920 may be used to communicate, for example, with one or more remote user platforms. Note that communications exchanged via the communication device 920 may utilize security features, such as those between a public internet user and an internal network of a business enterprise. The security features might be associated with, for example, web servers, firewalls, and/or PCI infrastructure. The smart analytics platform 900 further includes an input device 940 (e.g., a mouse and/or keyboard to enter information about user preferences) and an output device 950 (e.g., to output reports and displays regarding system administration and/or business data).

The processor 910 also communicates with a storage device 930. The storage device 930 may comprise any appropriate information storage device, including combinations of magnetic storage devices (e.g., a hard disk drive), optical storage devices, mobile telephones, and/or semiconductor memory devices. The storage device 930 stores a program 912 and/or a processing engine or application 914 for controlling the processor 910. The processor 910 performs instructions of the programs 912, 914, and thereby operates in accordance with any of the embodiments described herein. For example, the processor 910 may automatically execute a context determination tool, an expert knowledge tool, and a data interpretation tool using the business intelligence elements, key figures, and stream of big data. The processor 910 may then render a smart analytics interface display on a remote user device via a distributed communication network. The smart analytics interface display may, for example, include outputs of the context determination tool, expert knowledge tool, and data interpretation tool.

The programs 912, 914 may be stored in a compressed, uncompiled and/or encrypted format. The programs 912, 914 may furthermore include other program elements, such as an operating system, a database management system, and/or device drivers used by the processor 910 to interface with peripheral devices.

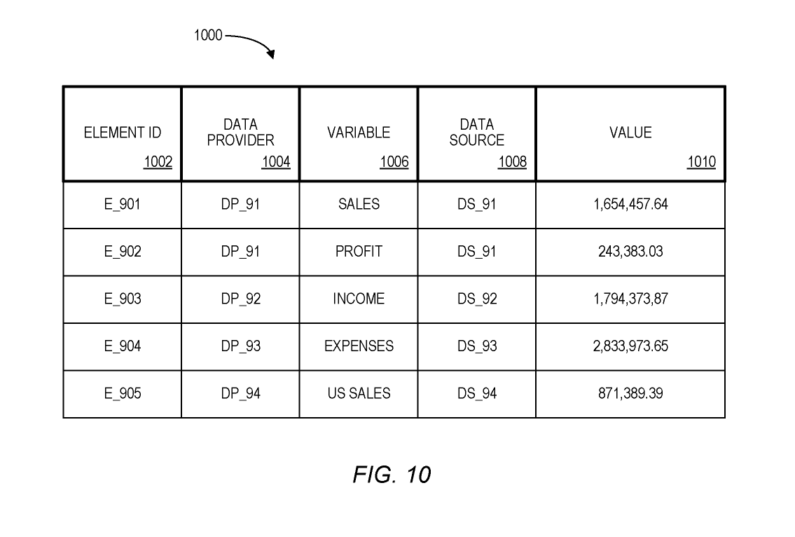

As used herein, information may be “received” by or “transmitted” to, for example: (i) the smart analytics platform 900 from another device; or (ii) a software application or module within the smart analytics platform 900 from another software application, module, or any other source. In some embodiments (such as shown in FIG. 9), the storage device 930 includes a key figures and big data database 1000. An example of a database that may be used in connection with the smart analytics platform 900 will now be described in detail with respect to FIG. 10. Note that the databases described herein are only examples, and additional and/or different information may be stored therein. Moreover, various databases might be split or combined in accordance with any of the embodiments described herein. For example, the key figures and big data database 1000 and processing engine 914 might be combined and/or linked to each other within the processing engine 1014.

Referring to FIG. 10, a table is shown that represents the key figures and big data database 1000 that may be stored at the smart analytics platform 900 according to some embodiments. The table may include, for example, entries identifying elements of business intelligence. The table may also define fields 1002, 1004, 1006, 1008, 1010 for each of the entries. The fields 1002, 1004, 1006, 1008, 1010 may, according to some embodiments, specify: an element identifier 1002, a data provider 1004, a variable 1006, a data source 1008, and a value 1010. The key figures and big data database 1000 may be created and updated, for example, based on information electrically received from data sources of a business enterprise.

The element identifier 1002 may be, for example, a unique alphanumeric code identifying a piece of business intelligence. The data provider 1004, variable 1006, and/or data source 1008 might define how information about the element is to be (or has been) obtained. The value 1010 might indicate a numerical amount associated with the element identifier 1002 (e.g., a monetary amount).

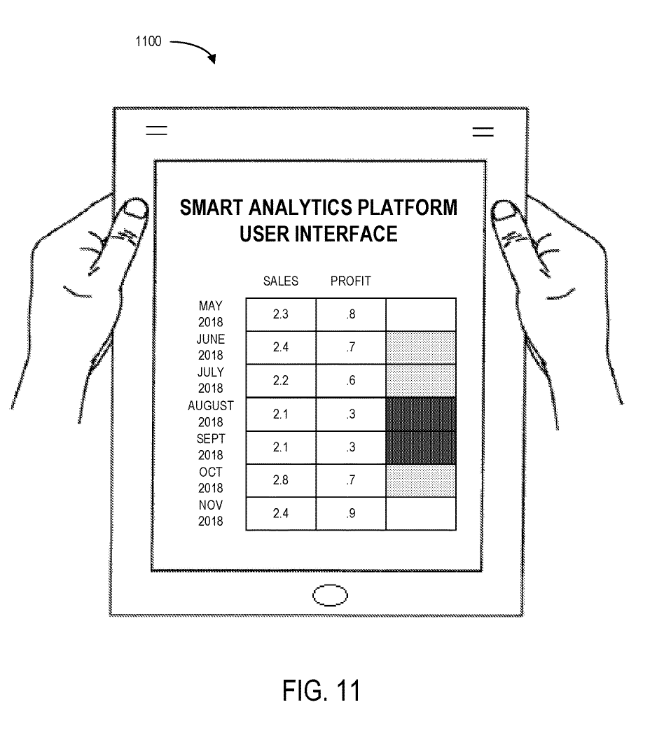

In this way, embodiments may support smart analytics for business intelligence. Note that the various displays described herein are provided only as example, and embodiments may be associated with any number of different implementations. For example, FIG. 11 illustrates a handheld tablet computer 1100 displaying a business intelligence heat map that may be associated with any of the embodiments described herein.

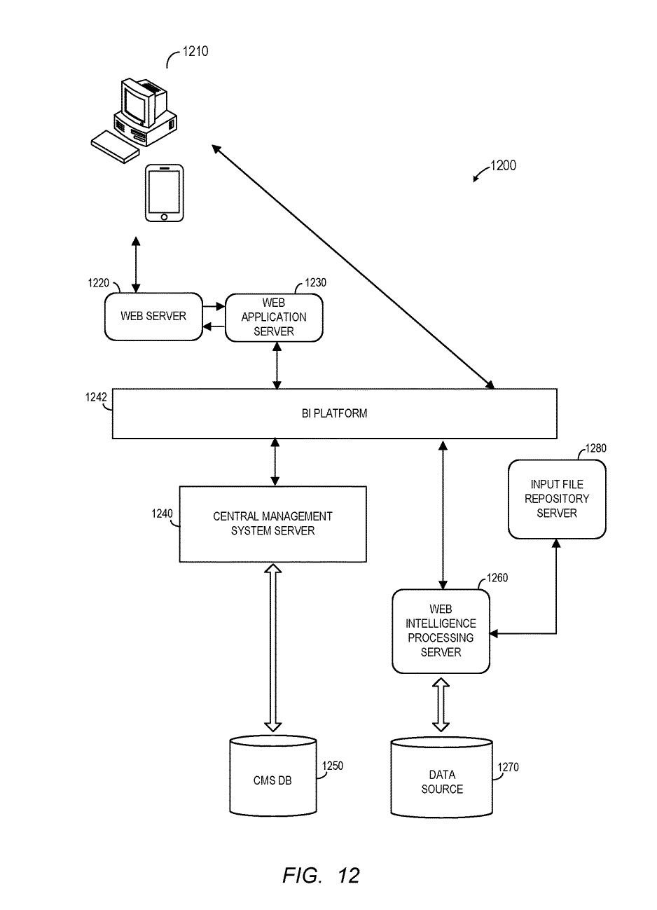

FIG. 12 is a block diagram of a system 1200 according to some embodiments. FIG. 12 represents a logical architecture for describing processes according to some embodiments, and actual implementations may include more or different components arranged in other manners. The system 1200 includes user devices 1210, such as PCs, smartphones, etc. that may access a web application server 1230 via a web server 1220. The web application server may, according to some embodiments, access a Central Management System (“CMS”) database 1250 via a Business Intelligence (“BI”) platform 1242 and a CMS server 1240. According to some embodiments, the web application server 1230 may send a request for a display to a web intelligence processing server 1260. The web intelligence processing server 1260 retrieves information from the input file repository server 1280 and queries data from a data source 1270 to feed it with data. For example, the web intelligence processing server 1260 may run a report engine that opens the document in memory and launch a connection server in processor. As a result, a Structured Query Language (“SQL”) or Multi-Dimensional eXpression (“MDX”) request may be generated (depending on the data source type), validated, and run to get the data from the data source 1270 (relational, OLAP, text file, spreadsheet) to be processed by the report engine. The web intelligence processing server 1260 may then send a viewable document page that was requested to the web application server 1230 (to eventually be viewed via the user devices 1210 via the web server 1220 or direct access to the server). Note that the various elements described herein may support multi-tenancy to separately support multiple unrelated clients by providing multiple logical database systems which are programmatically isolated from one another.

Some or all of the elements of the system 1200 may incorporate any of the smart analytics platforms, or portions of the smart analytics platforms, described herein. Although the system 1200 has been described as a distributed system, note that the system 1200 may be implemented in some embodiments by a single computing device. For example, both user devices 1210 and CMS server 1240 may be embodied by an application executed by a processor of a desktop computer, and the data source 1270 may be embodied by a fixed disk drive within the desktop computer. Although a single web application server 1230 is shown in FIG. 12, any number of such devices may be included. Moreover, various devices described herein might be combined according to embodiments of the present invention. For example, in some embodiments, the web application server 1230 and CMS server 1240 might be co-located and/or may comprise a single apparatus.

Thus, embodiments described herein may provide the commandments to an entire application that defines the boundary conditions for the application development. By embracing the design principles, the interpretation mechanism may present different challenges of data interpretation. Embodiments described herein address these challenges to solve the problem of interpreting business results in the context of big data.

The embodiments described herein are solely for the purpose of illustration. Those in the art will recognize other embodiments may be practiced with modifications and alterations limited only by the claims.

What is claimed is:

1. A system to improve a user data interface associated with a distributed communication network, comprising:
(a) a communication port to receive electronic messages containing business intelligence elements, key figures, and a stream of big data;
(b) a user interface to exchange information with a remote user device associated with a user; and
(c) a smart analytics platform, coupled to the communication port and the user interface, programmed to:
(i) access the business intelligence elements, key figures, and stream of big data,
(ii) automatically execute a context determination tool utilizing meta-data associated with at least one of the business intelligence elements, key figures, and stream of big data,
(iii) automatically execute an expert knowledge tool to process the business intelligence elements, key figures, and stream of big data,
(iv) automatically execute a data interpretation tool on the business intelligence elements, key figures, and stream of big data, and
(v) render a smart analytics interface display on the remote user device via the distributed communication network, the smart analytics interface display including outputs of the context determination tool, expert knowledge tool, and data interpretation tool.

2. The system of claim 1, wherein the context determination tool leverages received information by adding additional facts or values, reduces information noise, and suggests related elements based on available contextual information.

3. The system of claim 1, wherein the expert knowledge tool comprises internal, generic best-practices algorithms.

4. The system of claim 3, wherein the algorithms are associated with at least one of: outlier analysis, trend identification, and a plan versus actual comparison.

5. The system of claim 1, wherein the expert knowledge tool comprises external domain expertise to model domain specific rules.

6. The system of claim 1, wherein the data interpretation tool determines hidden correlations, patterns, or drivers associated with an enterprise.

7. The system of claim 6, wherein the data interpretation tool operates based at least in part on an enterprise role associated with the user.

8. The system of claim 6, wherein the data interpretation tool is configured to perform one of the following tasks: explain a business meaning of a specific key figure, explain an impact a specific key figure has on an enterprise, explain the consequences of a specific key figure, explain at least one decision that needs to be made along with a set of options associated with that decision, explain at least one next logical analysis step, suggest related reports or key figures, and propose other business aspects that may be associated with a specific key figure.

9. The system of claim 6, wherein the data interpretation tool is configured to receive from the user a request for increased data interpretation and, responsive to the received request, provide additional support information.

10. The system of claim 6, wherein the data interpretation tool includes a visual focus component, a comprehension component, and a textual conclusion component.

11. The system of claim 10, wherein the visual focus component is associated with a heat map.

12. The system of claim 10, wherein the comprehension component brings multiple perspectives of analysis by providing an overview to explain a specific key figure, suggesting dimensions via a relationship analyzer, accessing pre-determined dimensions and key figures, and summarizing findings.

13. The system of claim 12, wherein the summarized findings are provided to the user in human readable language.

14. A method implemented by a computing system in response to execution of program code by a processor of the computing system, the method to improve a user data interface associated with a distributed computer network and comprising:
receiving, via a communication port, electronic messages containing business intelligence elements, key figures, and a stream of big data;
accessing, by a computer processor of a smart analytics platform, the business intelligence elements, key figures, and stream of big data;
automatically executing, by the computer processor of the smart analytics platform, a context determination tool utilizing meta-data associated with at least one of the business intelligence elements, key figures, and stream of big data;
automatically executing, by the computer processor of the smart analytics platform, an expert knowledge tool to process the business intelligence elements, key figures, and stream of big data;
automatically executing, by the computer processor of the smart analytics platform, a data interpretation tool on the business intelligence elements, key figures, and stream of big data; and
rendering a smart analytics interface display on the remote user device via the distributed communication network, the smart analytics interface display including outputs of the context determination tool, expert knowledge tool, and data interpretation tool.

15. The method of claim 14, wherein the context determination tool leverages received information by adding additional facts or values, reduces information noise, and suggests related elements based on available contextual information.

16. The method of claim 14, wherein the expert knowledge tool comprises internal, generic best-practices algorithms associated with at least one of: outlier analysis, trend identification, and a plan versus actual comparison.

17. The method of claim 14, wherein the data interpretation tool determines hidden correlations, patterns, or drivers associated with an enterprise based at least in part on an enterprise role associated with the user.

18. The method of claim 14, wherein the data interpretation tool includes a visual focus component associated with a heat map, a comprehension component, and a textual conclusion component.

19. A non-transitory medium storing processor-executable program code, the program code executable by a processor of a computing device to improve a user data interface associated with a distributed communication network by:
receiving, via a communication port, electronic messages containing business intelligence elements, key figures, and a stream of big data;
accessing, by a computer processor of a smart analytics platform, the business intelligence elements, key figures, and stream of big data;
automatically executing, by the computer processor of the smart analytics platform, a context determination tool utilizing meta-data associated with at least one of the business intelligence elements, key figures, and stream of big data;
automatically executing, by the computer processor of the smart analytics platform, an expert knowledge tool to process the business intelligence elements, key figures, and stream of big data;
automatically executing, by the computer processor of the smart analytics platform, a data interpretation tool on the business intelligence elements, key figures, and stream of big data; and
rendering a smart analytics interface display on the remote user device via the distributed communication network, the smart analytics interface display including outputs of the context determination tool, expert knowledge tool, and data interpretation tool.

20. The medium of claim 19, wherein the context determination tool leverages received information by adding additional facts or values, reduces information noise, and suggests related elements based on available contextual information.

21. The medium of claim 19, wherein the expert knowledge tool comprises internal, generic best-practices algorithms associated with at least one of: outlier analysis, trend identification, and a plan versus actual comparison.

22. The medium of claim 19, wherein the data interpretation tool determines hidden correlations, patterns, or drivers associated with an enterprise based at least in part on an enterprise role associated with the user.

23. The medium of claim 19, wherein the data interpretation tool includes a visual focus component associated with a heat map, a comprehension component, and a textual conclusion component.
